(19) United States
(12) Patent Application Publication
(10) Pub. No.: US 2012/0175366 A1
(43) Pub. Date: Jul. 12, 2012

(54) VENT HOLE ALIGNMENT OF TEMPERATURE-PRESSURE RELIEF DEVICES ON PRESSURE VESSELS

(75) Inventors: Jörg Schulze, Mainz (DE); Oliver Maier, Worms (DE); Thomas Johnen, Nieder-Otm (DE)

(73) Assignee: GM GLOBAL TECHNOLOGY OPERATIONS LLC, Detroit, MI (US)

(21) Appl. No.: 12/987,329

(22) Filed: Jan. 10, 2011

(51) Int. Cl. B65D 90/34; B23P 17/00

(52) U.S. Cl. 220/89.1; 29/428

(57) ABSTRACT

A method for manufacturing a pressure vessel is provided. The method includes the steps of: providing the pressure vessel and a first temperature-pressure relief device, the temperature-pressure relief device having a housing; affixing the first temperature-pressure relief device to the pressure vessel; and forming a vent hole in the housing of the first temperature-pressure relief device after affixing the first temperature-pressure relieve device to the pressure vessel. The vent hole is selectively oriented in a desired direction via the method for manufacturing the pressure vessel. Temperature-pressure relief devices for vent hole alignment and selective orientation are also provided.

### FIELD OF THE INVENTION

The present disclosure relates to pressure vessels and more particularly to a temperature-pressure relief device on pressure vessels.

### BACKGROUND OF THE INVENTION

Fuel cell power systems have been proposed as a clean, efficient and environmentally responsible power source for electric vehicles and various other applications. One type of fuel cell power system employs use of a proton exchange membrane (PEM) to catalytically facilitate a reaction of fuels (such as hydrogen) and oxidants (such as air or oxygen) into electricity. Typically, the fuel cell power system has more than one fuel cell that includes an anode and a cathode with the PEM therebetween. The anode receives the hydrogen gas and the cathode receives the oxygen. The hydrogen gas is ionized in the anode to generate free hydrogen ions and electrons. The hydrogen ions pass through the electrolyte to the cathode. The hydrogen ions react with the oxygen and the electrons in the cathode to generate water as a by-product. The electrons from the anode cannot pass through the PEM, and are instead directed through a load to perform work before being sent to the cathode. The work acts to operate the vehicle. Many fuels cells are combined in a fuel cell stack to generate the desired power.

The hydrogen gas for the fuel cell power system can be processed separate from the vehicle and stored at a filling station and the like. The hydrogen gas may be transferred from the filling station to a high pressure vessel or container on the vehicle to supply the desired hydrogen gas to the fuel cell engine as needed. The high pressure vessels are typically classified into one of four types: a Type I vessel having an all-metal construction; a Type II having a metal lined construction with a fiberglass hoop wrap; a Type III having a metal lined construction with a composite full wrap; and a Type IV having a plastic lined construction with a composite full wrap.

High pressure vessels containing a compressed hydrogen gas must have a mechanical stability and an integrity that militates against a rupture or bursting of the pressure vessel from the pressure within. It is also typically desirable to make the pressure vessels on vehicles lightweight so as not to significantly affect the weight requirements of the vehicle. The current trend in the industry is to employ the Type IV pressure vessel for storing the compressed hydrogen gas on the vehicle.

As is reported by Immel in U.S. Pat. No. 6,742,554, herein incorporated by reference in its entirety, the Type IV pressure vessel contemplated in the industry for storage of hydrogen gas is cylindrical in shape to provide the desired integrity, and includes an outer structural wall and an inner liner defining a container chamber therein. The combination of the outer wall and the liner provide the desired structural integrity, pressure containment, and gas tightness in a light-weight and cost effective manner.

The Type IV pressure vessel typically includes an adapter that provides the inlet and the outlet opening for the hydrogen gas contained therein. The adapter typically houses the various valves, pressure regulators, piping connectors, excess flow limiter, etc. that allow the pressure vessel to be filled with the compressed hydrogen gas, and allow the compressed gas to be discharged from the pressure vessel at or near ambient pressure, or a higher pressure, to be sent to the fuel cell engine. The adapter is generally made of steel to provide a desired structural strength for storing compressed hydrogen gas. A suitable adhesive, sealing ring, or the like is employed to seal the liner to the adapter in a gas tight manner, and secure the adapter to the outer wall.

High pressure vessels are also generally designed with a thermally activated safety valve or temperature-pressure relief device (TPRD), typically located at the adapter or opening of the pressure vessel. A TPRD is a necessary component for a variety of reasons. In some cases, additional TPRDs located at other areas on the pressure vessel are used.

When activated, it is desirable for the TPRDs to release the pressure from the pressure vessel in generally downward direction. It has heretofore been complicated to ensure that all the release directions of multiple TPRDs are downward, i.e., generally orthogonal to a road surface, during installation of the TPRDs. Known concepts include the employment of heat shields to minimize a need for multiple TPRDs, complex TPRD designs with means for adjustment of a vent hole orientation, or very complex installation procedures to ensure that the release direction for each TPRD is substantially the same.

There is a continuing need for a TPRD structure and method for installing TPRDs that simplifies an adjustment of the TPRDs, facilitates an alignment of vent holes of the TPRDs, and minimizes a need for heat shields. Desirably, the TPRD structure and method of installation provides for simple adjustment during service, including reuse and/or replacement of the TPRD, and rapid dress up times during pressure vessel manufacturing.

### SUMMARY OF THE INVENTION

In concordance with the instant disclosure, a TPRD structure and method for installing TPRDs that simplifies an adjustment of the TPRDs, facilitates an alignment of vent holes of the TPRDs, minimizes a need for heat shields, and provides for simple adjustment during service, including reuse and/or replacement of the TPRD, and rapid dress up times during pressure vessel manufacturing, is surprisingly discovered.

In a first embodiment, a method for manufacturing a pressure vessel first includes the step of providing the pressure vessel and a first temperature-pressure relief device. The temperature-pressure relief device has a housing. The first temperature-pressure relief device is then affixed to the pressure vessel. A vent hole is formed in the housing of the first temperature-pressure relief device after the first temperature-pressure relieve device is affixed to the pressure vessel. The vent hole is thereby selectively oriented in a desired direction.

In another embodiment, a temperature-pressure relief device for a pressure vessel includes a temperature-pressure sensitive unit and a housing. The temperature-pressure sensitive unit is configured to relieve a pressure of the pressure vessel when at least one of a predetermined temperature and a predetermined pressure is exceeded. The temperature-pressure sensitive unit has an outlet through which the pressure is relieved, The housing is disposed over the outlet of the temperature-pressure sensitive unit. The housing is configured to have a vent hole formed therein. The vent hole is selectively oriented in a desired direction after the temperature-pressure relief device is affixed to the pressure vessel.

In a further embodiment, a temperature-pressure relief device for a pressure vessel includes a temperature-pressure sensitive unit and an outlet guidance unit. The temperature-pressure sensitive unit is configured to relieve a pressure of the pressure vessel when at least one of a predetermined temperature and a predetermined pressure is exceeded. The temperature-pressure sensitive unit has an outlet through which the pressure is relieved. The outlet guidance unit is disposed over the outlet of the temperature-pressure sensitive unit. The outlet guidance unit has an main body and a rotatable sleeve with a vent hole formed therein. The rotatable sleeve is rotatably disposed on the outlet guidance body. The vent hole is in fluid communication with a primary vent channel formed in the outlet guidance body, and in fluid communication with the temperature-pressure sensitive unit. The rotatable sleeve is configured to selectively orient the vent hole in a desired direction.

### DRAWINGS

The above, as well as other advantages of the present disclosure, will become readily apparent to those skilled in the art from the following detailed description, particularly when considered in the light of the drawings described hereafter.

FIG. 1 is a schematic side elevational view of a pressure vessel system with a temperature-pressure relief device according to one embodiment of the present disclosure;

FIG. 2A is an enlarged schematic fragmentary side cross-sectional elevational view of the temperature-pressure relief device illustrated in FIG. 1, shown prior to forming the vent hole in a housing of the temperature-pressure relief device;

FIG. 2B is an enlarged schematic fragmentary side cross-sectional elevational view of the temperature-pressure relief device illustrated in FIGS. 1 and 2A, shown after forming the vent hole in the housing of the temperature-pressure relief device;

FIG. 3 is an enlarged side cross-sectional elevational view of a thermal-pressure relief device according to another embodiment of the present disclosure, the temperature-pressure relief device including an outlet guidance device; and

FIG. 4 is an enlarged fragmentary side cross-sectional elevational view of the outlet guidance device illustrated in FIG. 3.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, are not necessary or critical.

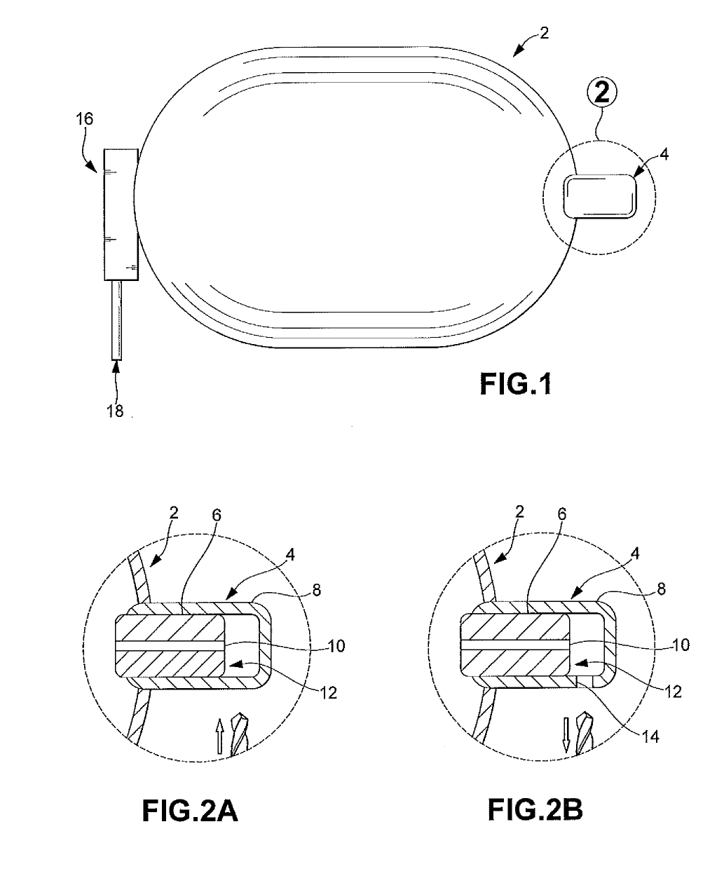

In one embodiment shown in FIGS. 1 and 2A-2B, the present disclosure includes a method for manufacturing a pressure vessel 2. The method first includes the steps of providing the pressure vessel 2 and a first temperature-pressure relief device (TPRD) 4. The pressure vessel 2 may be a hydrogen storage system (HSS), for example. Other types of pressure vessels 2 may also be used within the scope of the present disclosure.

The TPRD 4 has a temperature-pressure sensitive unit 6 and a housing 8. The temperature-pressure sensitive unit 6 is configured to relieve a pressure of the pressure vessel 2 when at least one of a predetermined temperature and a predetermined pressure is exceeded. The temperature-pressure sensitive unit 6 may be any type of temperature-pressure sensitive unit. As illustrative examples, the temperature-pressure sensitive unit 6 may be a temperature and/or pressure relief device as described in U.S. patent application Ser. No. 11/622,518 to Suess, U.S. patent application Ser. No. 12/116,321 to Pechtold, and U.S. patent application Ser. No. 12/138,544 to Lindner, et al., the entire disclosures of which are hereby incorporated herein by reference. A skilled artisan may select other structures and designs for the temperature-pressure sensitive unit 6 of the TPRD 4, as desired.

The temperature-pressure sensitive unit 6 has an outlet 10 at a free end 12 thereof, through which the pressure is relieved. The housing 8 covers the free end 10 of the temperature-pressure sensitive unit 6. The housing 8 of the TPRD 4 may be rotationally symmetrical, for example. Being rotationally symmetrical, the housing 8 may exhibit symmetry about a central axis of the housing 8. The housing 8 is initially provided without a vent hole 14 formed therein. It should be appreciated that an orientation of the TPRD 4 during installation in the pressure vessel is not critical, due to the absence of the vent hole 14.

The first TPRD 4 is installed into the pressure vessel 2 by affixing the first TPRD 4 to the pressure vessel 2. As a nonlimiting example, the step of affixing the TPRD 4 to the pressure vessel 2 may include screwing the TPRD 4 into a threaded boss of the pressure vessel 2. Alternatively, the TPRD 4 may be sealingly inserted into an aperture formed in the pressure vessel 2, and secured with adhesive or the like. Other means for affixing the TPRD 4 to the pressure vessel 2 may also be employed, as desired.

Following the installation of the first TPRD 4, the vent hole 14 is formed in the housing 8 of the first TPRD 4. As a nonlimiting example, the vent hole 14 may be formed by drilling the vent hole 14 through a wall of the housing 8. In an alternative embodiment, the vent hole 14 may be punched or stamped out of the wall of the housing 8. The vent hole 14 is selectively oriented in a desired direction when the vent hole 14 is formed. In a particularly illustrative embodiment, the vent hole 14 is oriented in a generally downward direction so that the vent hole 14 is disposed generally orthogonal to a road surface (not shown) on which a vehicle (not shown) with the pressure vessel 2 is operated.

One of ordinary skill in the art should appreciate that the forming of the vent hole 14 after the installation of the TPRD 4 into the pressure vessel 2 advantageously minimizes a need for adjustment of the TPRD 4 after installation to properly orient the vent hole 14. The vent hole 14 is always formed with the orientation in the desire direction, in accordance with the method of the present disclosure.

The present method may further include the step of providing a second TPRD 16. Unlike the first TPRD 4, the second TPRD 16 may be provided with a pre-formed vent hole 18. The pre-formed vent hole 18 is oriented in a generally downward direction when the second TPRD 16 is installed into pressure vessel 2. The second TPRD 16 is then affixed to the pressure vessel 2 at a location on the pressure vessel 2 spaced apart from the first TPRD 4, For example, the first TPRD 4 and the second TPRD 16 may be disposed at opposite ends of the pressure vessel 2. Alternatively, the second TPRD 16 may be installed into the pressure vessel 2 prior to the step of installing the first TPRD 4 into the pressure vessel 2. It should be appreciated that a plurality of additional TPRDs 4, 16 may also be installed into the pressure vessel 2, as desired.

Where the second TPRD 16 is employed, the desired direction of the vent hole 14 formed in the housing 8 of the first TPRD 4 is the same as an orientation of the pre-formed vent hole 18 in the second TPRD 16. In particularly illustrative embodiments, the orientation of each of the vent hole 14 and the pre-formed vent hole 18 is generally downward. Other orientations may also be used, although the downward direction is typically preferred.

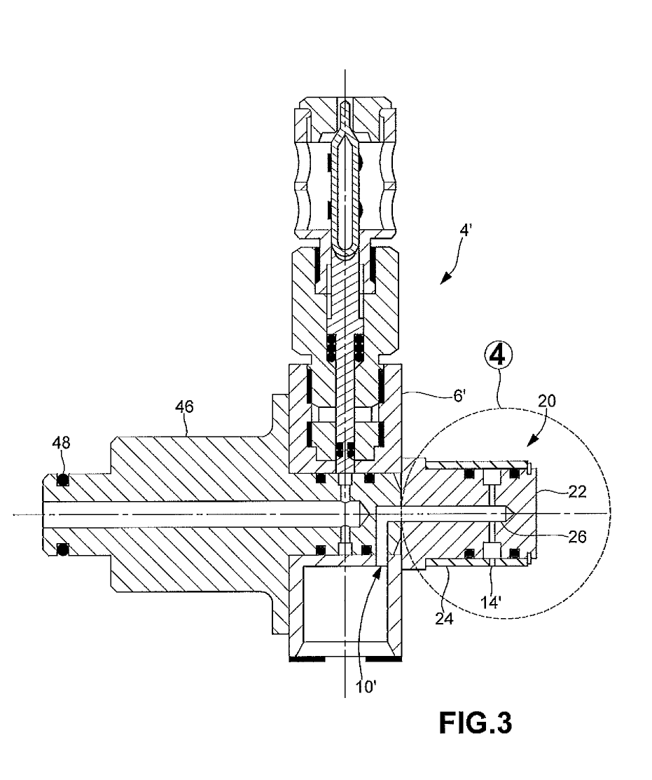

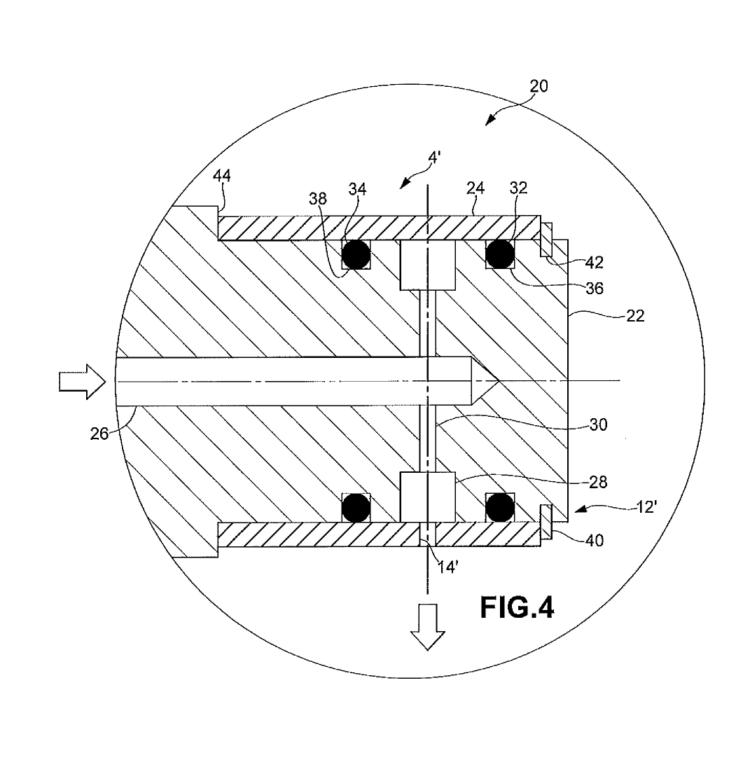

The TPRD 6′ according to another embodiment of the present disclosure is illustrated in FIGS. 3 and 4. Relative to FIGS. 1 and 2A-2B, like or related structure shown in FIGS. 3 and 4 is identified with the same reference numeral and a prime (′) symbol for the purpose of clarity.

The TPRD 4′ is configured to relieve a pressure of the pressure vessel 2′ when at least one of the predetermined temperature and the predetermined pressure is exceeded. The TPRD 4′ includes the temperature-pressure sensitive unit 6′ having the outlet 10′, through which the pressure is relieved. The TPRD 4′ also includes an outlet guidance unit 20. Like the housing 8 shown in FIGS. 1 and 2A-2B, the outlet guidance unit 20 is disposed over the outlet 10′ of the temperature-pressure sensitive unit 6′. The outlet guidance unit 20 has an main body 22 and a rotatable sleeve 24 with the vent hole 14′ formed therein. The rotatable sleeve 24 is rotatably disposed on the main body 22. The vent hole 14′ is in fluid communication with a primary vent channel 26 formed in the main body 22. The vent hole 14′ is thereby in fluid communication with the temperature-pressure sensitive unit 6′. It should be appreciated that the rotatable sleeve 24 is configured to selectively orient the vent hole 14′ in the desired direction.

With further reference to FIG. 4, the TPRD 4′ may include an annular vent channel 28. The annular vent channel 28 may be formed on the main body 22. The annular vent channel 28 is aligned with the vent hole 14′ formed in the rotatable sleeve 24. The annular vent channel 28 is also in fluid communication with the primary vent channel 26 via at least one vent hole 30, also formed in the main body 22.

In order to provide a substantially fluid-tight pathway for relief of pressure, the outlet guidance unit 20 may further include at least one seal 32, 34. The at least one seal 32, 34 is disposed between the rotatable sleeve 24 and the main body 22. For example, the at least one seal 32 may be an O-ring disposed in at least one annular groove 36, 38 formed in the main body 22. In a particular embodiment, the at least one seal 32, 34 includes a first O-ring 32 and a second O-ring 34. The first O-ring 32 is disposed in a first annular groove 36 disposed between the annular vent channel 28 and the free end 12′ of the main body 22. The second O-ring 34 is disposed in a second annular groove 38 disposed between the annular vent channel 28 and the temperature-pressure relief unit 6′. The O-ring seals 32, 34 further militate against an undesired rotation of the sleeve 24. The friction torque is related to a diameter of the O-ring seals 32, 34 and a pre-stress of the O-ring seals 32, 34, which allows the O-ring seals 32, 34 to serve a double function, i.e., sealing and fixation.

In a further embodiment, the rotatable sleeve 24 is secured to the main body 22 with a retaining ring 40. The retaining ring 40 may be disposed in a groove 42 disposed adjacent the free end 12′ of the main body 22, for example. The main body 22 may also have a step 44 formed therein. The rotatable sleeve 24 may thereby be secured to the main body 22 between the retaining ring 40 and the step 44. Other means for securing the rotatable sleeve 24 to the main body 22 may also be employed, as desired.

With renewed reference to FIG. 3, the TPRD 4′ of the present disclosure may further include an on-tank valve (OTV) 46. The OTV 46 may be configured to be affixed to the pressure vessel 2. For example, the OTV 46 may be threaded and configured to threadedly engage a boss of the pressure vessel 2. As shown in FIG. 3, the OTV 46 may be provided with one or more seals 48 configured to provide a fluid-tight seal with the pressure vessel 2. Other known types of OTVs 46 may also be employed within the scope of the present disclosure.

In a particular embodiment, the temperature-pressure sensitive unit 6′ is disposed between and in fluid communication with the OTV 46 and the outlet guidance unit 20. It should be appreciated that the temperature-pressure sensitive unit 6′ permits fluid flow from the OTV 46, temperature-pressure sensitive unit 6′, to the outlet guidance unit 20 when at least one of the predetermined temperature and the predetermined pressure is exceeded.

The method and TPRD 4, 4′ of the present disclosure advantageous provides means to assure an optimum direction or orientation of the vent hole 14, 14′ so as to release pressure in a desired manner, i.e. generally downwards. The method and TPRD 4, 4′ also facilitates an alignment of respective vent holes 14, 14′, 18 of different TPRDs 4, 4′, 16 at different locations on the pressure vessel. The forming of the vent hole 14 after installation of the TPRD 4, in particular, minimizes the need for adjustable parts, eliminates the typically high effort adjustment itself, and spare seals for the adjustment systems. Likewise, the adjustment of the vent hole 14′ on the rotatable sleeve 24 after installation of the TPRD 4′ is simple and can be rapidly performed during manufacture of the pressure vessel 2.

While certain representative embodiments and details have been shown for purposes of illustrating the invention, it will be apparent to those skilled in the art that various changes may be made without departing from the scope of the disclosure, which is further described in the following appended claims.

What is claimed is:

1. A method for manufacturing a pressure vessel, the method including the steps of:
providing the pressure vessel and a first temperature-pressure relief device, the temperature-pressure relief device having a housing;
affixing the first temperature-pressure relief device to the pressure vessel; and
forming a vent hole in the housing of the first temperature-pressure relief device after affixing the first temperature-pressure relieve device to the pressure vessel, the vent hole selectively oriented in a desired direction.

2. The method of claim 1, wherein the step of affixing the temperature-pressure relief device to the pressure vessel includes screwing the temperature-pressure relief device into a threaded boss of the pressure vessel.

3. The method of claim 1, wherein the housing of the temperature-pressure relief device is rotationally symmetrical.

4. The method of claim 1, wherein the step of forming the vent hole in the housing includes drilling the vent hole in the housing.

5. The method of claim 1, further comprising the steps of:
providing a second temperature-pressure relief device having a pre-formed vent hole; and
affixing the second temperature-pressure relief device to the pressure vessel at a location spaced apart from the first temperature-pressure relief device.

6. The method of claim 5, wherein the desired direction of the vent hole formed in the housing of the first temperature-pressure relief device is the same as an orientation of the pre-formed vent hole in the second temperature-pressure relief device.

7. The method of claim 1, wherein the desired direction of the vent hole formed in the housing of the first temperature-pressure relief device is a generally downward direction.

8. A temperature-pressure relief device for a pressure vessel, comprising:
a temperature-pressure sensitive unit configured to relieve a pressure of the pressure vessel when at least one of a predetermined temperature and a predetermined pressure is exceeded, the temperature-pressure sensitive unit having an outlet through which the pressure is relieved; and
a housing covering the outlet of the temperature-pressure sensitive unit, the housing configured to have a vent hole formed therein and selectively oriented in a desired direction after the temperature-pressure relief device in affixed to the pressure vessel.

9. The temperature-pressure relief device of claim 8, wherein the housing of is rotationally symmetrical, and the desired direction of the vent hole formed in the housing of the first temperature-pressure relief device is a generally downward direction.

10. A temperature-pressure relief device for a pressure vessel, comprising;
a temperature-pressure sensitive unit configured to relieve a pressure of the pressure vessel when at least one of a predetermined temperature and a predetermined pressure is exceeded, the temperature-pressure sensitive unit having an outlet through which the pressure is relieved; and
an outlet guidance unit disposed over the outlet of the temperature-pressure sensitive unit, the outlet guidance unit having an main body and a rotatable sleeve with a vent hole formed therein, the rotatable sleeve rotatably disposed on the outlet guidance body, the vent hole in fluid communication with a primary vent channel formed in the main body and in fluid communication with the temperature-pressure sensitive unit, the rotatable sleeve configured to selectively orient the vent hole in a desired direction.

11. The temperature-pressure relief device of claim 10, wherein an annular vent channel is formed on the outlet guidance body, the annular vent channel aligned with the vent hole formed in the rotatable sleeve.

12. The temperature-pressure relief device of claim 11, wherein the annular vent channel is in fluid communication with the primary vent channel by at least one vent hole formed in the outlet guidance body.

13. The temperature-pressure relief device of claim 12, wherein at least one seal is dispose between the rotatable sleeve and the outlet guidance body.

14. The temperature-pressure relief device of claim 13, wherein the at least one seal is an O-ring disposed in at least one annular groove formed in the main body between the annular channel and one of a free end of the main body and the temperature-pressure relief unit.

15. The temperature-pressure relief device of claim 13, wherein the at least one seal includes a first O-ring and a second O-ring, the first O-ring disposed in a first annular groove disposed between the annular channel and the free end of the outlet guidance body, the second O-ring disposed in a second annular groove disposed between the annular channel and the temperature-pressure relief unit.

16. The temperature-pressure relief device of claim 10, wherein the rotatable sleeve is secured to the main body with a retaining ring.

17. The temperature-pressure relief device of claim 16, wherein the main body has a step formed therein, the rotatable sleeve secured to the main body between the retaining ring and the step.

18. The temperature-pressure relief device of claim 17, wherein the retaining ring is disposed in a groove adjacent the free end of the outlet guidance body.

19. The temperature-pressure relief device of claim 10, further comprising an on-tank valve configured to be affixed to the pressure vessel.

20. The temperature-pressure relief device of claim 19, wherein the temperature-pressure sensitive unit is disposed between and in fluid communication with the on-tank valve and the outlet guidance unit, the temperature-pressure sensitive unit permitting fluid flow from the on-tank valve to the outlet guidance unit when at least one of the predetermined temperature and the predetermined pressure is exceeded.
